(19) United States
(12) Patent Application Publication
(10) Pub. No.: US 2017/0331972 A1
(43) Pub. Date: Nov. 16, 2017

(54) ELECTRONIC APPARATUS AND NON-TRANSITORY COMPUTER READABLE RECORDING MEDIUM

(71) Applicant: KYOCERA DOCUMENT SOLUTIONS INC., OSAKA (JP)

(72) Inventor: KYOTA MITSUYAMA, OSAKA (JP)

(21) Appl. No.: 15/589,851

(22) Filed: May 8, 2017

(30) Foreign Application Priority Data
May 12, 2016 (JP) 2016-095956

(51) Int. Cl. H04N 1/21; H04N 1/00

(52) U.S. Cl. CPC H04N 1/2179; H04N 1/00954; H04N 1/00938; H04N 2201/214; H04N 2201/218; H04N 2201/0094

(57) ABSTRACT

An electronic apparatus includes: a storage device; an application program execution circuit that executes an application program for managing input/output of data to/from the storage device; a counter control circuit that counts the number of execution of the application program and records a time and date of the execution; a retention period setting circuit that obtains execution frequency of the application program based on the time and date recorded by the counter control circuit, and sets a retention period of the data stored in the storage device depending on the obtained execution frequency; and a data deletion circuit that deletes the data from the storage device when the retention period has passed.

### CROSS REFERENCE TO RELATED APPLICATION

This application claims the benefit of Japanese Priority Patent Application JP2016-095956 filed May 12, 2016, the entire contents of which are incorporated herein by reference.

### BACKGROUND OF THE INVENTION

### 1. Field of the Invention

The present disclosure relates to an electronic apparatus that manages a capacity of retained data and a non-transitory computer readable recording medium that records a file management program.

### 2. Description of Related Art

In an electronic apparatus such as an image forming apparatus (MFP, Multifunction Peripheral), a capacity of a storage device is limited.

### SUMMARY OF THE INVENTION

An electronic apparatus according to an embodiment of the present disclosure includes:
a storage device;
an application program execution circuit that executes an application program for managing input/output of data to/from the storage device;
a counter control circuit that counts the number of execution of the application program and records a time and date of the execution;
a retention period setting circuit that
   obtains execution frequency of the application program based on the time and date recorded by the counter control circuit, and
   sets a retention period of the data stored in the storage device depending on the obtained execution frequency; and
a data deletion circuit that deletes the data from the storage device when the retention period has passed.

A non-transitory computer readable recording medium according to an embodiment of the present disclosure records a file management program, the program file management program causing a computer to operate as:
an application program execution circuit that executes an application program for managing input/output of data to/from a storage device;
a counter control circuit that counts the number of execution of the application program and records a time and date of the execution;
a retention period setting circuit that
   obtains execution frequency of the application program based on the time and date recorded by the counter control circuit, and
   sets a retention period of the data stored in the storage device depending on the obtained execution frequency; and
a data deletion circuit that deletes the data from the storage device when the retention period has passed.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 schematically shows a configuration of an image forming apparatus 20;

FIG. 2 shows an example of a retention period table 29c;

FIG. 3 shows a flow of processing executed when a user stores data by using a BOX function;

FIG. 4 shows a flow of processing executed when the user uses data stored by using the BOX function;

FIG. 5 shows a flow of processing executed when the user uses the data stored by using the BOX function;

FIG. 6 shows a flow of processing executed when the user uses the data stored by using the BOX function; and

FIG. 7 shows a flow of processing of automatically deleting box data 29b in the case where a retention period of the box data 29b has passed.

### DETAILED DESCRIPTION OF THE PREFERRED EMBODIMENTS

Hereinafter, an embodiment of the present disclosure will be described with reference to the drawings. Note that in the description below, an image forming apparatus is exemplified as an electronic apparatus according to an embodiment of the present disclosure.

1. General Outline

First, a general outline will be described.

In general, in the case of using a data retention function (e.g., a BOX function (to be described later)) of an image forming apparatus, retained data of each user may occupy the majority of the capacity of a storage device of an image forming apparatus.

In the case where the storage capacity of the image forming apparatus reaches the limit, generally, this state can be eliminated by deleting unnecessary data or adding a storage device. However, in order to determine the necessity of data and delete the data, it takes time to examine the content of data. Further, also in the case of adding a storage device, additional cost is necessary.

In this regard, an image forming apparatus according to an embodiment of the present disclosure calculates, for each user, execution frequency of an application program such as a data retention function, sets a retention period of data depending on the calculated execution frequency, and retains and delete the data based on the set retention period. Note that the retention period represents a period from when data is stored in a storage device 29 (to be described later) of the image forming apparatus.

By calculating, for each user, execution frequency of an application program and setting a retention period of data depending on the calculation result as described above, it is possible to flexibly set a retention period for each user.

It is possible to appropriately manage the amount of use of the storage device of the image forming apparatus by automatically deleting the retained data of a user with low execution frequency of an application.

Note that in the description below, a BOX application program that provides a BOX function is exemplified as an application related to a data retention function.

In the BOX function, a BOX that is a data storing area is provided to the image forming apparatus for each user, data of the user is stored in the BOX, and the data in the BOX can be appropriately retrieved, printed, and transmitted via a network or through a FAX.

Note that the BOX function has a function in which the retained data can be shared and used by each user.

The general outline has been described heretofore.

2. Configuration of Image Forming Apparatus

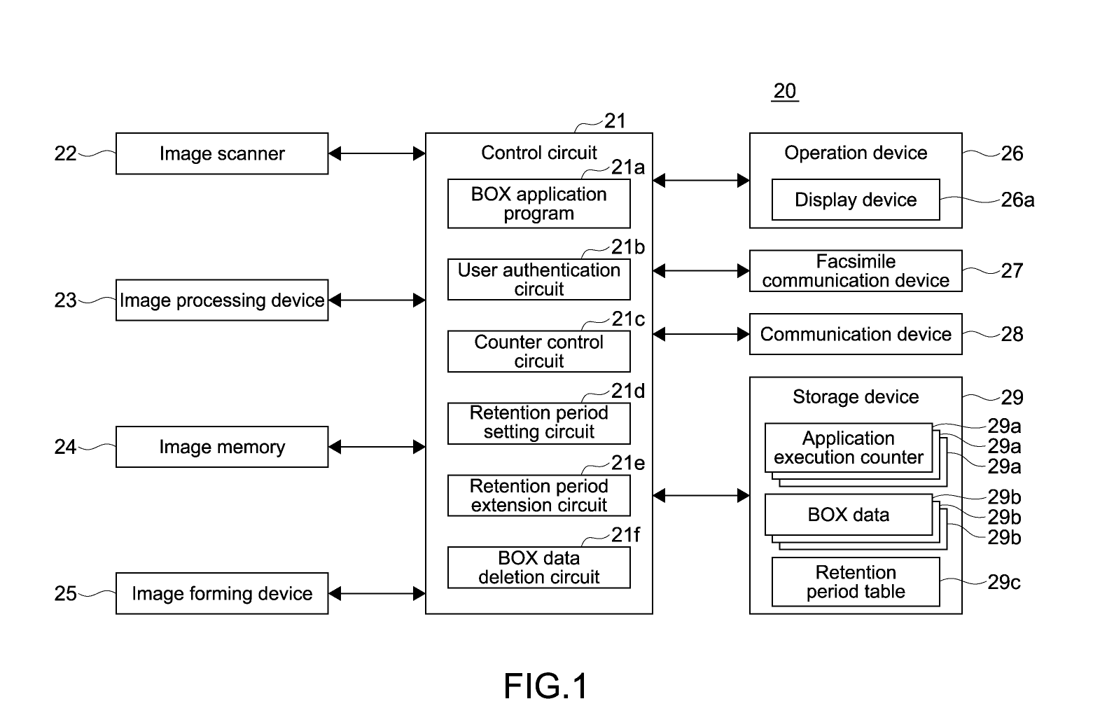

Next, a configuration of an image forming apparatus 20 will be described. FIG. 1 schematically shows the configuration of the image forming apparatus 20.

The image forming apparatus 20 includes a control circuit 21. The control circuit 21 includes a CPU (Central processing unit), a RAM (Random access memory), a ROM (Read only memory), dedicated hardware circuits, and the like and performs overall operational control of the image forming apparatus 20.

The control circuit 21 is connected to an image scanner 22, an image processing device 23, an image memory 24, an image forming device 25, an operation device 26, a display device 26a, a facsimile communication device 27, a communication device 28, and a storage device 29, and the like. The control circuit 21 performs operational control of the respective devices connected thereto and sends/receives signals and data to/from those devices.

According to job execution instructions input by a user via the operation device 26 or a personal computer (PC) connected to a network, the control circuit 21 controls drive and processing of mechanisms requisite for executing operational control of functions such as a scanner function, a printing function, a copy function, a BOX function, and a facsimile sending/receiving function.

Further, the control circuit 21 includes a BOX application program execution circuit 21a (application program execution circuit), a user authentication circuit 21b, a counter control circuit 21c, a retention period setting circuit 21d, a retention period extension circuit 21e, and a BOX data deletion circuit 21f (data deletion circuit).

A CPU loads programs recorded in a ROM or the like, which is an example of a non-transitory computer readable recording medium, in a RAM and executes the programs to thereby operate as the functional blocks, i.e., the BOX application program execution circuit 21a, the user authentication circuit 21b, the counter control circuit 21c, the retention period setting circuit 21d, the retention period extension circuit 21e, and the BOX data deletion circuit 21f.

The BOX application program execution circuit 21a executes a BOX application program. The BOX application program provides a BOX function to a user. Specifically, the BOX application program execution circuit 21a inputs/outputs data to/from BOX data 29b for each user. The BOX data 29b is provided to the storage device 29.

The user authentication circuit 21b authenticates and uniquely identifies a user.

The counter control circuit 21c counts, for each user, the number of execution of a BOX application program by the BOX application program execution circuit 21a by using application execution counter 29a (to be described later) provided for each user.

The counter control circuit 21c records the time and date of execution of a BOX application program by the BOX application program execution circuit 21a when performing the counting. Therefore the counter control circuit 21c can obtain the number of execution in the last X days from now.

The retention period setting circuit 21d obtains execution frequency of a BOX application program by the BOX application program execution circuit 21a based on a value of the application execution counter 29a, and sets, depending on the obtained execution frequency, the retention period of the BOX data 29b by using a retention period table 29c (to be described later).

The retention period extension circuit 21e extends the retention period of the BOX data 29b of the user every time the BOX application program execution circuit 21a executes an application program.

The BOX data deletion circuit 21f automatically deletes the BOX data 29b whose retention period has passed.

The image scanner 22 reads an image from a script.

The image processing device 23 carries out image processing as necessary on image data of an image read by the image scanner 22. For example, the image processing device 23 corrects shading of an image read by the image scanner 22 and carries out other image processing to improve the quality of the image to be formed.

The image memory 24 includes an area that temporarily stores data of a script image read by the image scanner 22 or data to be printed by the image forming device 25.

The image forming device 25 forms an image of image data and the like read by the image scanner 22.

The operation device 26 includes a touch panel device and an operation key device that accept user's instructions on various operations and processing executable by the image forming apparatus 20. The touch panel device includes the display device 26a such as an LCD (Liquid Crystal Display) equipped with a touch panel.

The facsimile communication device 27 includes an encoding/decoding device, a modulation/demodulation device, and an NCU (Network Control Unit) (all of which are not shown) and transmits facsimiles using a public telephone network.

The communication device 28 is constituted of a communication module such as a LAN board and sends/receives various types of data to/from an apparatus such as an external PC and a mobile terminal in a local area via a LAN connected to the communication device 28, and the like.

The storage device 29 stores a script image read by the image scanner 22, the application execution counter 29a provided for each user, the BOX data 29b for each user, which corresponds to a BOX whose data is stored by using a BOX function, the retention period table 29c (table) for setting, for each user, a retention period depending on the execution frequency of a BOX application program by the BOX application program execution circuit 21a, and the like. The storage device 29 is a large-volume storage device such as an HDD (Hard Disk Drive) and an SSD (Solid State Drive).

The configuration of the image forming apparatus 20 has been described heretofore.

3. Regarding Retention Period Table

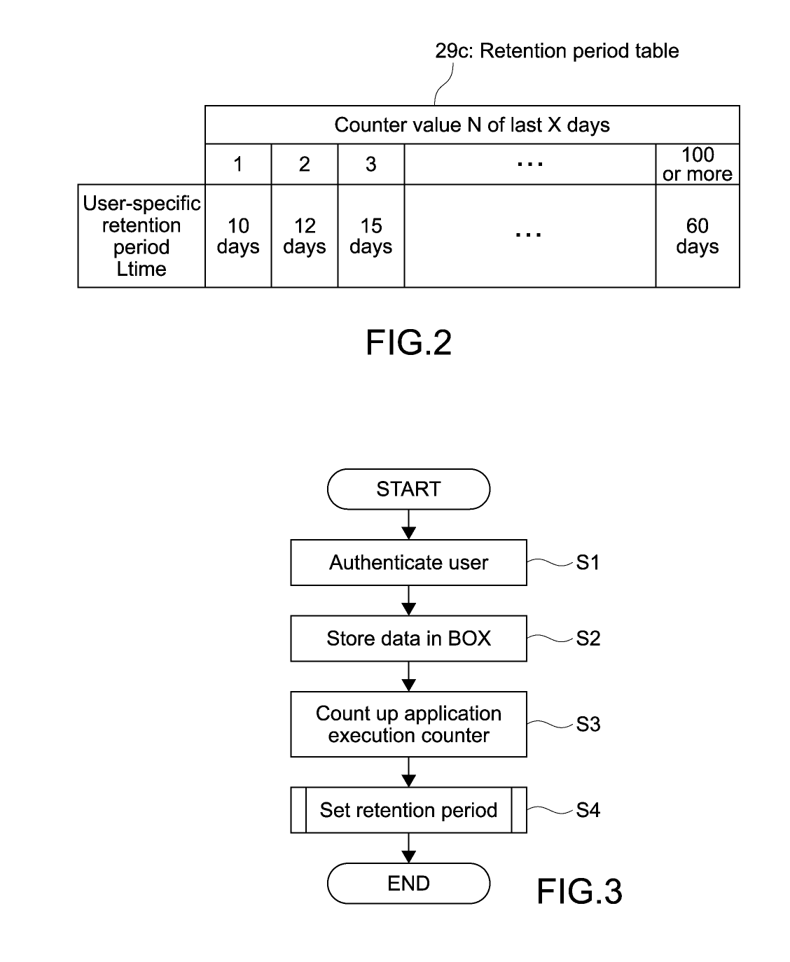

Next, the above-mentioned retention period table 29c will be described. FIG. 2 shows an example of the retention period table 29c.

In this example, a user-specific retention period Ltime is set depending on the execution frequency of the BOX application program by the BOX application program execution circuit 21a for a particular user, i.e., a counter value N (N is a positive number) of the application execution counter 29a in the last X days (X is a value set in advance, such as 7).

For example, in the case where the counter value N in the last X days is 3, the user-specific retention period Ltime is set to 15 days based on the table shown in FIG. 2.

Further, the user-specific retention period Ltime may have an upper limit. In the example shown in FIG. 2, in the case where the counter value N exceeds 100, the user-specific retention period Ltime is set to 60 days, the upper limit of the user-specific retention period Ltime being 60 days.

Note that the table is used to obtain the user-specific retention period Ltime based on the counter value N in the description above. Alternatively, the user-specific retention period Ltime may be obtained based on the counter value N by using a mathematical expression.

The retention period table 29c has been described heretofore.

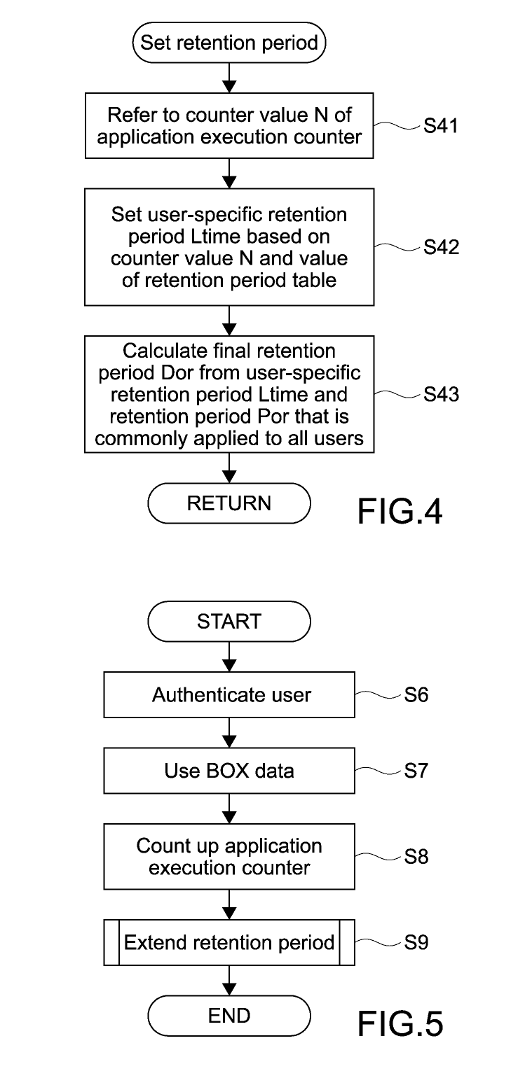

4. Flow of Processing (When Storing Data)
Next, a flow of processing of storing data by using a BOX function by the image forming apparatus 20 will be described. FIG. 3 and FIG. 4 each show a flow of processing of storing data by using a BOX function.

First, as shown in FIG. 3, the user authentication circuit 21b authenticates a user who intends to store data in his BOX by using the BOX application program execution circuit 21a (Step S1).

With the user authentication, the image forming apparatus 20 can recognize and identify the user.

Next, the BOX application program execution circuit 21a accepts data to be stored and stores the data in the appropriate BOX data 29b (Step S2).

Next, the counter control circuit 21c counts up the application execution counter 29a of the corresponding user (Step S3).

Next, the retention period setting circuit 21d performs processing of setting a retention period of BOX data for each user (Step S4).

Next, as shown in FIG. 4, the retention period setting circuit 21d refers to the counter value N of the application execution counter 29a of the corresponding user in the processing of setting a retention period (Step S41).

Next, the retention period setting circuit 21d sets the user-specific retention period Ltime based on the counter value N and the value of the retention period table 29c (Step S42). In the case where the value in the above-mentioned example is used, Ltime is 15 when N is 3.

Next, the retention period setting circuit 21d calculates a final retention period Dor based on the user-specific retention period Ltime set in the previous step and a retention period Por that is commonly applied to all users (Step S43).

Note that the final retention period Dor may be calculated by using the following equation: Dor=Ltime+Por. In this case, in the case where Ltime is 15, for example, Dor is 25 when Por is 10. Thus, the BOX data 29b is retained for 25 days.

Note that the processing of setting a retention period is performed when storing data of a user in a BOX in the description above. Alternatively, the processing of setting a retention period may be performed when the image forming apparatus 20 is powered on, or at a particular point of time set by an administrator, for example.

Note that the processing of setting a retention period is performed every time a user stores data in a BOX in the description above (i.e., the retention period is extended or shortened when the execution frequency of an application program by a user is changed). Alternatively, the processing of setting a retention period may be performed only when a user stores data in a BOX for the first time.

The flow of processing executed when storing data of a user by using the BOX function in the image forming apparatus 20 has been described heretofore.

5. Flow of Processing (When Using Retained Data)

Next, a flow of processing executed when a user uses the data that is retained in the image forming apparatus 20 by using the BOX function will be described.

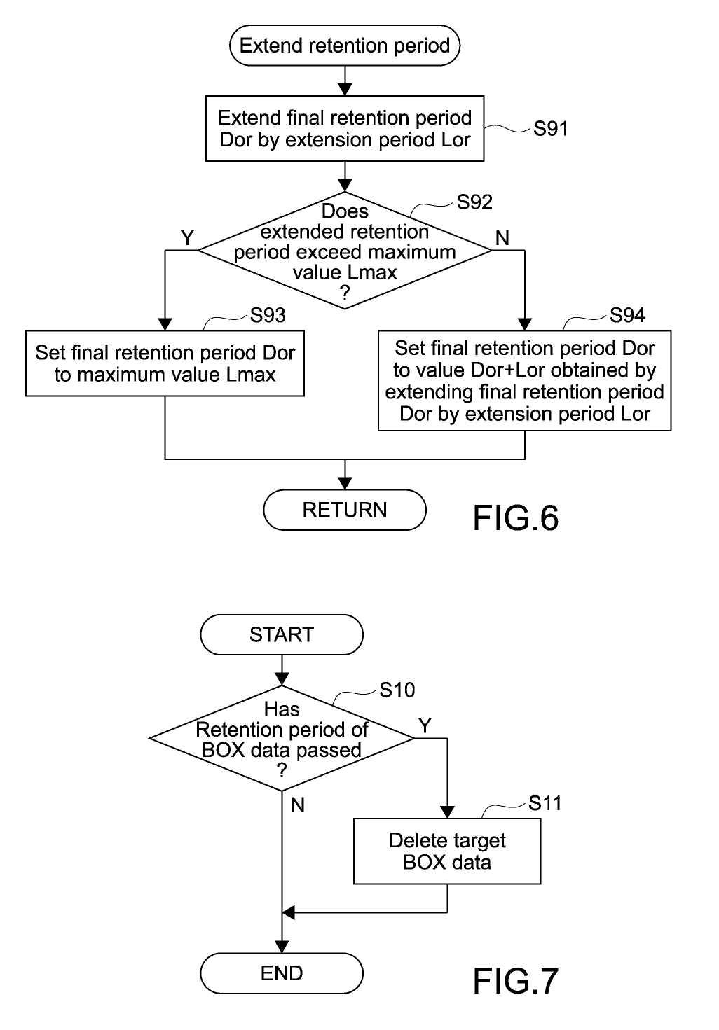

FIG. 5 and FIG. 6 each show a flow of processing executed when a user uses the data that is retained by using the BOX function.

First, as shown in FIG. 5, the user authentication circuit 21b authenticates a user who intends to use the data retained in his BOX by using the BOX application program execution circuit 21a (Step S6).

Next, the BOX application program execution circuit 21a retrieves data retained in the BOX of the authenticated user, and the user uses the data. Note that herein, the use of data represents, for example, printing the retrieved data or transmitting the data via a network or through a FAX.

Next, the counter control circuit 21c counts up the application execution counter 29a of the corresponding user (Step S8).

Next, the retention period extension circuit 21e performs processing of extending a retention period of BOX data for each user (Step S9).

Next, as shown in FIG. 6, the retention period extension circuit 21e extends the final retention period Dor of BOX data of the corresponding user by a specific extension period Lor in the processing of extending a retention period (Step S91). The value of the extension period Lor is, for example, 10 days.

Next, the retention period extension circuit 21e determines whether or not the extended final retention period Dor exceeds a maximum value Lmax of the retention period (Step S92). The value of the maximum value Lmax is, for example, 180 days.

In the case where the extended final retention period Dor exceeds the maximum value Lmax of the retention period (Y in Step S92), the retention period extension circuit 21e sets the final retention period Dor to the maximum value Lmax (Step S93).

In the case where the extended final retention period Dor does not exceed the maximum value Lmax of the retention period (N in Step S92), the retention period extension circuit 21e sets the final retention period Dor to a value obtained by extending the final retention period Dor by the extension period Lor (Dor+Lor) (Step S94).

Note that the extension period Lor used for the calculation of extending the period is a constant value in the description above. Alternatively, a table or mathematical expression may be used for changing the extension period Lor depending on the counter value N of the application execution counter 29a, similarly to the processing of setting the retention period.

The flow of processing executed when a user uses the data that is retained in the image forming apparatus 20 by using the BOX function has been described heretofore.

6. Flow of Processing (Automatic Deletion of BOX Data)

Next, a flow of processing of automatically deleting the BOX data 29b in the image forming apparatus 20 in the case where the retention period of the BOX data 29b has passed will be described. FIG. 7 shows a flow of processing of automatically deleting the BOX data 29b in the case where the retention period of the BOX data 29b has passed.

Note that the following processing may be automatically performed when the image forming apparatus 20 is powered on or at the time (e.g., every Tuesday or 2:00 A.M. every day) set by an administrator or the like.

First, the BOX data deletion circuit 21f determines whether or not the set retention period of the BOX data 29b of each user has passed (Step S10).

When the retention period has not passed (N in Step S10), the processing is finished.

When the retention period has passed (Y in Step S10), the BOX data deletion circuit 21f deletes the target BOX data 29b (Step 511).

The flow of processing of automatically deleting the BOX data 29b of the image forming apparatus 20 in the case where the retention period of the BOX data 29b has passed has been described heretofore.

7. Supplementary Note

Note that even in the case where a plurality of pieces of data are retained in a BOX, the whole data is collectively handled as a single piece of BOX data 29b in the description above. Alternatively, the plurality of pieces of data retained in the BOX may be individually managed.

Specifically, the retention period setting circuit 21d may perform, in Step S4, the processing of setting a retention period on the data to be stored in Step S2 shown in FIG. 3. Further, the retention period extension circuit 21e may perform, in Step S9, the processing of extending a retention period on the data to be used in Step S7 shown in FIG. 5.

In the description above, a BOX application program that provides a BOX function is exemplified as an application program executed by the application program execution circuit 21a. Alternatively, the present embodiment is applicable to a program that inputs/outputs data to/from the storage device 29 and manages data, as an application program executed by the application program execution circuit 21a.

In the description above, a user is identified by user authentication, and the number of execution of a BOX application program by the BOX application program execution circuit 21a is counted for each user. In addition to this configuration, the present embodiment is applicable also to shared data stored in a BOX shared by a plurality of users.

In this case, another application execution counter 29a common to all users may be provided. Alternatively, the execution frequency of a BOX application program may be obtained by comprehensively using values of the application execution counters 29a of all users, e.g., based on the total value or average value of the application execution counters 29a of all users, and the retention period may be determined based on the retention period table 29c.

The BOX data 29b whose retention period has passed is deleted in the description above. Alternatively, the BOX data 29b whose size exceeds a particular value and whose retention period has passed may be deleted, for example.

As described above, the electronic apparatus (image forming apparatus) 20 according to the present embodiment includes the storage device 29, the application program execution circuit 21a that executes an application program for managing input/output of data to/from the storage device 29, the counter control circuit 21c that counts the number of execution of the application program and records a time and date of the execution, the retention period setting circuit 21d that obtains execution frequency of the application program based on the time and date recorded by the counter control circuit 21c and sets a retention period of the data stored in the storage device 29 depending on the obtained execution frequency, and the data deletion circuit 21f that deletes the data from the storage device 29 when the retention period has passed.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus, comprising:
a storage device;
an application program execution circuit that executes an application program for managing input/output of data to/from the storage device;
a counter control circuit that counts the number of execution of the application program and records a time and date of the execution;
a retention period setting circuit that
obtains execution frequency of the application program based on the time and date recorded by the counter control circuit, and
sets a retention period of the data stored in the storage device depending on the obtained execution frequency; and
a data deletion circuit that deletes the data from the storage device when the retention period has passed.

2. The electronic apparatus according to claim 1, further comprising
a user authentication circuit that authenticates and uniquely identifies a user, wherein
the counter control circuit counts, for each user, the number of execution of the application program, and records a time and date of the execution, and
the retention period setting circuit
obtains, for each user, the execution frequency of the application program based on the time and date recorded by the counter control circuit, and
sets the retention period of the data stored in the storage device depending on the obtained execution frequency.

3. The electronic apparatus according to claim 2, wherein
the retention period setting circuit
obtains execution frequency of the application program by a plurality of users by comprehensively using the time and date recorded by the counter control circuit for each user, and
sets a retention period of the data stored in the storage device depending on the obtained execution frequency.

4. The electronic apparatus according to claim 1, wherein
the retention period setting circuit sets the retention period of the data by using a table, the retention period of the data depending on the execution frequency of the application program being defined in the table.

5. The electronic apparatus according to claim 1, further comprising
a retention period extending circuit that extends the retention period of the data every time the application program execution circuit executes the application program.

6. The electronic apparatus according to claim 5, wherein
the retention period extending circuit extends, for each piece of data, the retention period of the data every time the application program execution circuit executes the application program.

7. The electronic apparatus according to claim 1, wherein
the counter control circuit counts, for each piece of data, the number of execution of the application program, and records a time and date of the execution, and
the retention period setting circuit
obtains, for each piece of data, the execution frequency of the application program based on the time and date recorded by the counter control circuit, and
sets, for each piece of data, a retention period of the data stored in the storage device depending on the obtained execution frequency.

8. The electronic apparatus according to claim 1, wherein
the data deletion circuit deletes the data from the storage device where a size of the data exceeds a particular value and the retention period has passed.

9. A non-transitory computer readable recording medium that records a file management program, the program file management program causing a computer to operate as:
an application program execution circuit that executes an application program for managing input/output of data to/from a storage device;
a counter control circuit that counts the number of execution of the application program and records a time and date of the execution;
a retention period setting circuit that
obtains execution frequency of the application program based on the time and date recorded by the counter control circuit, and
sets a retention period of the data stored in the storage device depending on the obtained execution frequency; and
a data deletion circuit that deletes the data from the storage device when the retention period has passed.
